(19) United States
(12) Patent Application Publication
(10) Pub. No.: US 2025/0370468 A1
(43) Pub. Date: Dec. 4, 2025

(54) OBSTACLE AVOIDANCE PROMPTING METHOD, DEVICE, COMPUTER DEVICE, AND STORAGE MEDIUM

(71) Applicant: ARASHI VISION INC., Shenzhen (CN)

(72) Inventors: Chunhong DENG, Shenzhen (CN); Yongjie HUANG, Shenzhen (CN); Chen SHI, Shenzhen (CN); Rui XU, Shenzhen (CN); Wei Wu, Shenzhen (CN)

(73) Assignee: ARASHI VISION INC., Shenzhen (CN)

(21) Appl. No.: 19/223,432

(22) Filed: May 30, 2025

(30) Foreign Application Priority Data
May 31, 2024 (CN) 202410695497.7

(51) Int. Cl. G05D 1/622; G05D 1/224; G05D 109/20; G05D 111/10; G06T 3/4038; G06T 3/60; G06T 7/50

(52) U.S. Cl. CPC G05D 1/622; G05D 1/2247; G06T 3/4038; G06T 3/60; G06T 7/50; G05D 2109/20; G05D 2111/10; G06T 2207/10028; G06T 2207/10032

(57) ABSTRACT

An obstacle avoidance prompting device may include circuitry configured to receive a shooting image captured by a moving object; display a real-time image in an interactive interface of a display, wherein the real-time image corresponds to an image of at least a partial area of the shooting image; if a moving direction of the moving object is within a shooting range, display a first obstacle avoidance prompt information in the real-time image; and if the moving direction of the moving object is outside the shooting range, display moving direction prompt information and displaying a second obstacle avoidance prompt information in a first preset area in the real-time image.

### CROSS-REFERENCE TO RELATED APPLICATION

The present application claims priority to Chinese Patent Application No. 202410695497.7, filed May 31, 2024, the entire content being incorporated herein by reference in its entirety.

### TECHNICAL OF FIELD

The present disclosure relates to a field of obstacle avoidance prompts, and in particular to an obstacle avoidance prompt method, device, computer device and storage medium.

### BACKGROUND

In recent years, with continuous iteration of electronic equipment software technology and rapid development of hardware manufacturing, moving devices such as unmanned aerial vehicles (UAVs) have been widely used in military fields and civilian fields such as aerial photography and mapping. During use of a moving device, images captured by the moving device can be displayed on a display device that is connected to the moving device, and obstacle avoidance prompt can be provided to a user in a form of an image or text.

### SUMMARY

In one embodiment, an obstacle avoidance prompting method may include receiving a shooting image captured by a moving object or device; displaying a real-time image in an interactive interface of a display, wherein the real-time image corresponds to an image of at least a partial area of the shooting image; in a case that a moving direction of the moving object is within a shooting range corresponding to the real-time image, displaying first obstacle avoidance prompt information in the real-time image; and in a case that the moving direction of the moving object is outside the shooting range corresponding to the real-time image, displaying moving direction prompt information in the real-time image and displaying second obstacle avoidance prompt information in a first preset area in the real-time image

In another embodiment, an obstacle avoidance prompting device may include circuitry configured to receive a shooting image captured by a moving object; display a real-time image in an interactive interface of a display, wherein the real-time image corresponds to an image of at least a partial area of the shooting image; in a case that a moving direction of the moving object is within a shooting range corresponding to the real-time image, display first obstacle avoidance prompt information in the real-time image; and in a case that the moving direction of the moving object is outside the shooting range corresponding to the real-time image, displaying travel direction prompt information in the real-time image and displaying second obstacle avoidance prompt information in a first preset area in the real-time image. In another embodiment, a computer device may include at least one memory and at least one processor, wherein the at least one memory stores a computer program, wherein the at least one processor, when executing the computer program, is configured to receive a shooting image captured by a moving object; display a real-time image in an interactive interface of a display, wherein the real-time image corresponds to an image of at least a partial area of the shooting image; in a case that a moving direction of the moving object is within a shooting range corresponding to the real-time image, display first obstacle avoidance prompt information in the real-time image; and if the moving direction of the moving object is outside the shooting range corresponding to the real-time image, displaying travel direction prompt information in the real-time image and displaying second obstacle avoidance prompt information in a first preset area in the real-time image.

In another embodiment, a non-transitory computer-readable storage medium is provided, on which a computer program is stored. When the computer program is executed by a processor, the steps of the method described in the embodiment of the present disclosure are implemented.

The technical solution provided by some embodiments of the present disclosure may include the following beneficial effects: the first obstacle avoidance prompt information and the second obstacle avoidance prompt information can respectively prompt obstacles within and outside the shooting range corresponding to the real-time image, and the moving direction prompt information can prompt the moving direction outside the real-time image. No matter what changes occur in the shooting range corresponding to the real-time image and the moving direction of the moving object, the moving direction of the moving object and the obstacles in the moving direction can be prompted through the real-time image, thereby ensuring the applicability and accuracy of the obstacle avoidance prompt and the safety of the use of the moving object, thereby improving the user experience.

It is to be understood that the foregoing general description and the following detailed description are exemplary and explanatory only and are not restrictive of the present disclosure.

### BRIEF DESCRIPTION OF THE DRAWINGS

In order to more clearly illustrate the technical solutions in the embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 is a diagram showing an application scenario of an obstacle avoidance prompt method according to an exemplary embodiment.

FIG. 2 is a flow chart of an obstacle avoidance prompt method according to an exemplary embodiment.

FIG. 3 is a schematic diagram showing a moving direction of a moving device and a shooting range corresponding to a real-time image according to an exemplary embodiment.

FIG. 4 is a schematic diagram showing a moving direction of a moving device and a shooting range corresponding to a real-time image according to another exemplary embodiment.

FIG. 5 is a flowchart showing a method of displaying first obstacle avoidance prompt information in a real-time image based on information for confirming an obstacle according to an exemplary embodiment.

FIG. 6 is a schematic diagram showing color marking of first target obstacles in a real-time image according to an exemplary embodiment.

FIG. 7 is a schematic diagram showing dot matrix marking of each first target obstacle in a real-time image according to an exemplary embodiment.

FIG. 8 is a flowchart showing a method of determining at least one first target obstacle in a real-time image based on information for confirming obstacles according to an exemplary embodiment.

FIG. 9 is a schematic diagram showing a real-time image according to an exemplary embodiment.

FIG. 10 is a flowchart showing a method of displaying second obstacle avoidance prompt information in a first preset area based on information for confirming obstacles according to an exemplary embodiment.

FIG. 11 is a flowchart showing a method of determining at least one second target obstacle in a moving image based on information for confirming obstacles according to an exemplary embodiment.

FIG. 12 is a schematic diagram of a moving image according to an exemplary embodiment.

FIG. 13 is a flowchart showing a color labeling or pattern labeling process according to an exemplary embodiment.

FIG. 14 is a flow chart of an obstacle avoidance prompt method according to another exemplary embodiment.

FIG. 15 is a block diagram of an obstacle avoidance prompt device according to an exemplary embodiment.

FIG. 16 is a block diagram of a computer device according to an exemplary embodiment. In the figure:

1-moving object or device; 2-display device; 3-remote control device; 10-first preset area; 20-second preset area; 30-moving direction indicator icon; 40-third preset area; 50-receiving module; 60-display module; 70-first prompt module; 80-second prompt module; 100-computer device; 101-computing unit; 102-ROM; 103-RAM; 104-bus; 105-input/output interface; 106-input unit; 107-output unit; 108-storage unit; 109-communication unit.

### DETAILED DESCRIPTION

Exemplary embodiments will be described in detail herein, examples of which are shown in the accompanying drawings. When the following description refers to the drawings, the same numbers in different drawings represent the same or similar elements unless otherwise indicated. The embodiments described in the following exemplary embodiments do not represent all embodiments consistent with the present disclosure. Instead, they are merely examples of devices and methods consistent with some aspects of the present disclosure as detailed in the appended claims.

In the description of the embodiments of the present application, the technical terms “first”, “second”, “third,” etc. are merely used for distinguishing different objects, and are not to be construed as indicating or implying relative importance or implicitly indicating the number, particular order or primary-secondary relationship of the indicated technical features. In the description of the embodiments of the present application, the singular forms of “a,” “an,” and “the” used in this specification and the appended claims are also intended to encompass the plurality, unless the context clearly indicates otherwise. It should also be understood that the term “and/or” as used herein refers to and encompasses any or all possible combinations of one or more of the associated listed items.

In recent years, with continuous iteration of electronic equipment, software technology and rapid development of hardware manufacturing level, moving objects or devices such as UAVs have been widely used in military and civilian fields. A moving device is usually used in conjunction with a display device, which can display images taken by the moving device and provide obstacle avoidance prompt to a user in a form of an image or text on the displayed image.

However, when using the obstacle avoidance prompt methods in the related technology, a shooting range of the displayed image and a moving direction of the moving device need to be basically consistent. When the moving direction of the moving device is outside the shooting range of the displayed image, the user cannot know the moving direction of the moving device and obstacle situation in the moving direction through the displayed image. In the scenario where the moving direction of the moving device is outside the shooting range of the displayed image, it is difficult to avoid an obstacle in the moving direction according to the obstacle avoidance prompt. There are problems such as insufficient applicability and accuracy of the obstacle avoidance prompt and low safety in the use of the moving device, resulting in poor user experience.

Based on this, an exemplary embodiment of the present disclosure provides an obstacle avoidance prompt method, which receives a shooting image taken by a moving device and displays a real-time image in an interactive interface of a display device, and can display first obstacle avoidance prompt information when the moving direction is within a shooting range corresponding to the real-time image, and display moving direction prompt information and second obstacle avoidance prompt information when the moving direction is outside the shooting range corresponding to the real-time image, so as to realize obstacle avoidance prompts and moving direction prompt in different scenarios through real-time images. The first obstacle avoidance prompt information and the second obstacle avoidance prompt information can respectively prompt an obstacle within and outside the shooting range corresponding to the real-time image, and the moving direction prompt information can prompt the moving direction outside the real-time image. Regardless of any changes in the shooting range corresponding to the real-time image and the moving direction of the moving device, the moving direction of the moving device and the obstacle situation in the moving direction can be prompted through the real-time image, thereby ensuring applicability and accuracy of the obstacle avoidance prompt and safety of use of the moving device, thereby improving user experience.

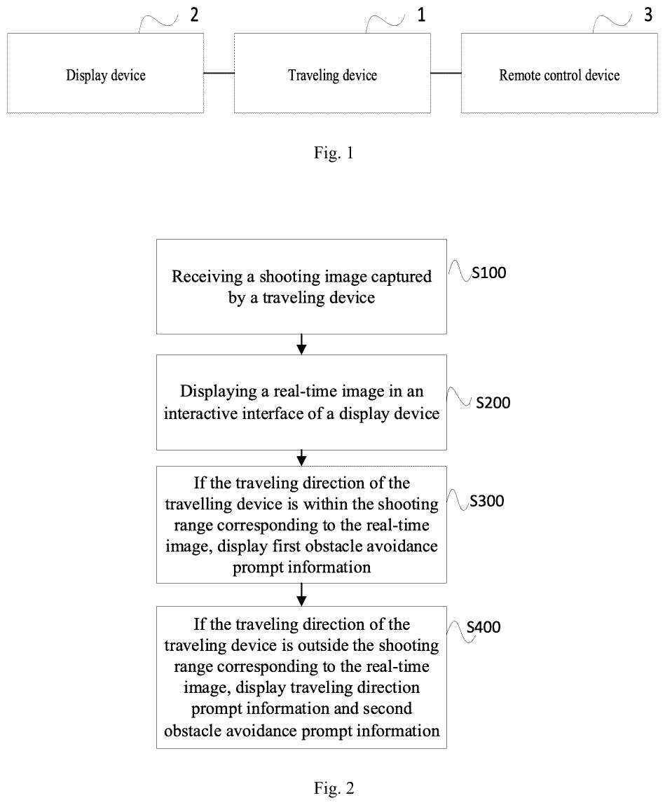

The obstacle avoidance prompt method provided in one embodiment of the present application can be applied to an application scenario shown in FIG. 1, which includes a moving device or structure 1, a display device or display 2 and a remote control device or controller 3. The moving device 1 is communicatively connected to the display device 2 and the remote control device 3 respectively, and can receive a shooting image taken by the moving device 1 through the display device 2, display the real-time image in an interactive interface of the display device 2, and selectively display first obstacle avoidance prompt information or moving direction prompt information and second obstacle avoidance prompt information based on whether the moving direction is within or outside the shooting range corresponding to the real-time image. The user can adjust the moving direction of the moving device 1 through the remote control device 3 according to the first obstacle avoidance prompt information or the second obstacle avoidance prompt information to avoid obstacles. The moving device 1 can be, for example, a UAV, a remote-controlled car, etc., and the display device 2 can be, for example, a wearable device such as a pair of glasses or a terminal device such as a mobile phone. The type of the display device 2 is not limited thereto. The obstacle avoidance prompt method provided in this embodiment can be used for display devices 2 that have problems such as insufficient applicability and accuracy of obstacle avoidance prompt. In an exemplary embodiment, an obstacle avoidance prompt method is provided, which is applied to a display device 2, where the display device 2 may be, for example, a wearable device such as a pair of glasses or a terminal device such as a mobile phone capable of displaying an image. Referring to FIG. 2, the obstacle avoidance prompt method includes: S100: receiving a shooting image captured by a moving device.

In step S100, the display device 2 receives a shooting image captured by the moving device 1. The shooting image captured by the moving device 1 can reflect a viewing angle from a location of the moving device 1. When the moving device 1 moves, the shooting image captured by the moving device 1 changes synchronously.

Exemplarily, the moving device 1 is a UAV, the display device 2 is a pair of glasses, the UAV is communicatively connected to the glasses, the camera installed on the UAV can be used to capture an image, and image data corresponding to the captured image can be sent to the glasses, so that the glasses receive the image captured by the UAV.

S200: displaying a real-time image in an interactive interface of a display device, where the real-time image corresponds to an image of at least a partial area in the shooting image. In step S200, a real-time image is displayed in the interactive interface of the display device 2. The real-time image may be the entire shooting image, or may be an image of a partial area in the shooting image, so that the user can observe the real-time image shot by the moving device 1 through the interactive interface of the display device 2 to feel the current viewing angle of the moving device 1. When the real-time image corresponds to the image of a partial area in the shooting image, the shooting range corresponding to the real-time image is smaller than the shooting range corresponding to the shooting image, and the moving direction of the moving device 1 may be within the shooting range corresponding to the real-time image, or may be outside the shooting range corresponding to the real-time image. S300: if the moving direction of the moving device is within the shooting range corresponding to the real-time image, display first obstacle avoidance prompt information in the real-time image.

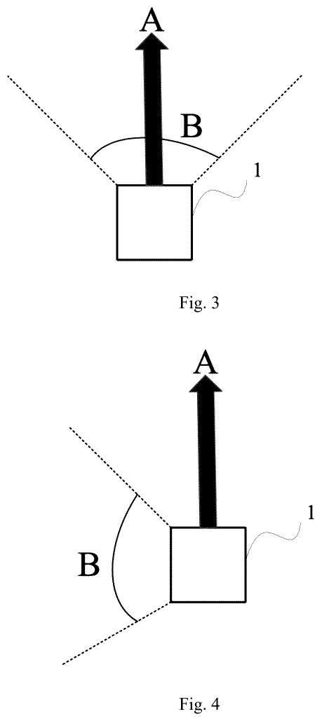

In step S300, as shown in FIG. 3, if the moving direction A of the moving device 1 is within the shooting range B corresponding to the real-time image, it is necessary to provide first obstacle avoidance prompt information for an obstacle within the shooting range corresponding to the real-time image, and the first obstacle avoidance prompt information can be directly displayed in the real-time image. The first obstacle avoidance prompt information is configured to prompt a first target obstacle in the real-time image, and the first obstacle avoidance prompt information can be displayed by marking the first target obstacle in the real-time image with color, dot matrix or grid.

S400: if the moving direction of the moving device is outside the shooting range corresponding to the real-time image, display moving direction prompt information in the real-time image, and display second obstacle avoidance prompt information in a first preset area in the real-time image.

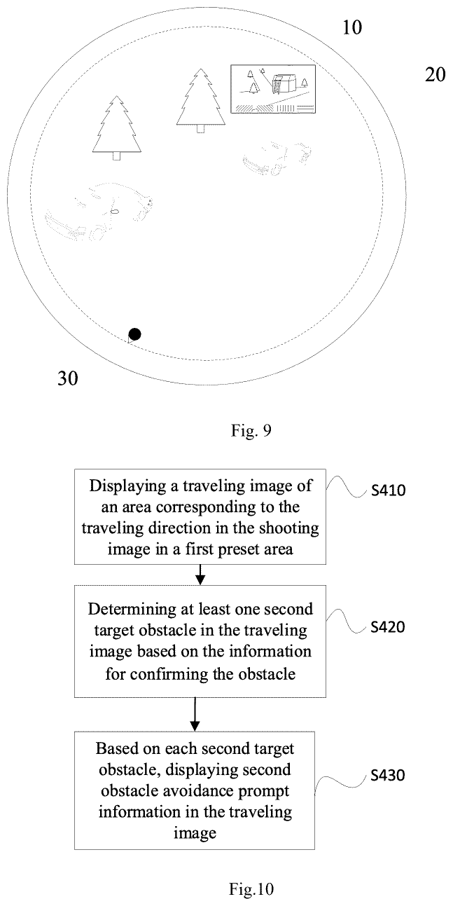

In step S400, as shown in FIG. 4, if the moving direction A of the moving device 1 is outside the shooting range B corresponding to the real-time image, it is necessary to provide obstacle avoidance prompts for the moving direction of the moving device 1 and an obstacle in the moving direction. As shown in FIG. 9, the moving direction prompt information can be directly displayed in the real-time image, and the second obstacle avoidance prompt information can be displayed in the first preset area 10 of the real-time image. Exemplarily, a position of the first preset area 10 can be located near an edge of the real-time image, and a range of the first preset area 10 can be 1/10 of the real-time image, so as to avoid blocking most of the real-time image when the second obstacle avoidance prompt information is displayed in the first preset area 10.

The moving direction prompt information can prompt the moving direction of the moving device 1, and the user can determine a relative position of the moving direction of the moving device 1 in the real-time image according to the prompt information. The second obstacle avoidance prompt information is used to prompt a second target obstacle in the moving direction, and the second obstacle avoidance prompt information can be displayed by color marking or pattern marking in a specific area within the first preset area 10. It should be noted that an area position in the shooting image corresponding to the real-time image and the moving direction of the moving device 1 may change during the movement of the moving device 1. By adopting the obstacle avoidance prompt method of the present application, no matter what changes occur in the shooting range corresponding to the real-time image and the moving direction of the moving device 1, that is, the shooting range corresponding to the real-time image and the moving direction are in any relative positional relationship, the moving direction of the moving device 1 and the obstacle in the moving direction can be prompted by the first obstacle avoidance prompt information or the moving direction prompt information combined with the second obstacle avoidance prompt information.

In this embodiment, by receiving the shooting image captured by the moving device 1 and displaying the real-time image in the interactive interface of the display device 2, the first obstacle avoidance prompt information can be displayed when the moving direction is within the shooting range corresponding to the real-time image. The moving direction prompt information and the second obstacle avoidance prompt information can be displayed when the moving direction is outside the shooting range corresponding to the real-time image, so that obstacle avoidance prompts and moving direction prompt in different scenarios can be realized through the real-time image. The first obstacle avoidance prompt information and the second obstacle avoidance prompt information can respectively prompt an obstacle within and outside the shooting range corresponding to the real-time image, and the moving direction prompt information can prompt the moving direction outside the real-time image. Regardless of any changes in the shooting range corresponding to the real-time image and the moving direction of the moving device 1, the moving direction of the moving device 1 and the obstacle situation in the moving direction can be prompted through the real-time image, thereby ensuring the applicability and accuracy of the obstacle avoidance prompt and the safety of using the moving device 1, thereby improving the user experience.

In some embodiments, the shooting image includes a panoramic image captured by a panoramic camera of the moving device 1, and the real-time image corresponds to an image of a partial area in the panoramic image.

The shooting image taken by the moving device 1 may be a panoramic image taken by a panoramic camera of the moving device 1. The panoramic image is an image with a wide field of view that can provide a 360-degree viewing angle by splicing multiple image frames, so that the shooting image can cover all viewing angles from the location of the moving device 1. The real-time image corresponds to an image of a partial area in the panoramic image, and the real-time image can be obtained by determining a position of the corresponding area of the real-time image in the panoramic image and obtaining the area corresponding to the real-time image in the panoramic image by cropping.

In this embodiment, by using the panoramic image captured by the panoramic camera of the travelling device 1 as the shooting image, and making the real-time image correspond to the image of a partial area in the panoramic image, it is possible to achieve the correspondence between the real-time image and the partial area in the shooting image, and ensure that the shooting image has a wide field of view, so that the user can select an appropriate real-time image from the shooting image with a wide field of view according to actual needs, thereby improving user experience.

In some embodiments, the obstacle avoidance prompt method further includes: adjusting the area of the panoramic image corresponding to the real-time image in response to a user's viewing angle adjustment operation.

The user can perform a viewing angle adjustment operation in the interactive interface, and the viewing angle adjustment operation can be, for example, clicking a viewing angle adjustment control in the interactive interface or dragging the real-time image in a specific direction. When the display device 2 recognizes the user's viewing angle adjustment operation, the position of the area of the panoramic image corresponding to the real-time image is adjusted. The user can select the position of the area corresponding to the real-time image in the panoramic image having a wide field of view, i.e., the shooting image, by performing the viewing angle adjustment operation, so that the image that the user wants to observe can be presented in the real-time image.

In this embodiment, the display device 2 can adjust the area of the panoramic image corresponding to the real-time image in response to the user's perspective adjustment operation, so that the user can select the position of the area corresponding to the real-time image in the panoramic image having a wide field of view, i.e., the shooting image, by performing the perspective adjustment operation, so that the real-time image has adjustable properties, and can prompt the travel direction of the moving device 1 and the obstacle in the moving direction through the first obstacle avoidance prompt information or the travel direction prompt information combined with the second obstacle avoidance prompt information when the real-time image changes arbitrarily, thereby improving the user experience.

In some embodiments, the obstacle avoidance prompt method further includes: receiving information for confirming an obstacle obtained by the moving device 1. Displaying the first obstacle avoidance prompt information in the real-time image includes: based on the information for confirming the obstacle, displaying the first obstacle avoidance prompt information in the real-time image

In order to display the first obstacle avoidance prompt information, it is necessary to determine the obstacle in the real-time image, so it is necessary to receive the information for confirming the obstacle obtained by the moving device 1. For example, the information for confirming the obstacle may include a depth image captured by the moving device 1 through a camera or sensor data obtained by a sensor. After receiving the information for confirming the obstacle obtained by the moving device 1, a first target obstacle can be determined according to the information for confirming the obstacle, so as to display the first obstacle avoidance prompt information in the real-time image to prompt the first target obstacle. In this embodiment, by receiving the information for confirming the obstacle obtained by the moving device 1, the information for confirming the obstacle can be used as the basis for confirming an obstacle, so that the first obstacle avoidance prompt information can be displayed in the real-time image according to the information for confirming the obstacle, so that when the moving direction is within the shooting range corresponding to the real-time image, the obstacle situation in the moving direction can be prompted through the first obstacle avoidance prompt information, thereby ensuring the applicability and accuracy of the obstacle avoidance prompt and the safety of using the moving device 1, thereby improving the user experience.

In some embodiments, the obstacle avoidance prompt method further includes: receiving information for confirming an obstacle obtained by the moving device 1. Displaying second obstacle avoidance prompt information in the first preset area 10 in the real-time image includes: displaying the second obstacle avoidance prompt information in the first preset area 10 based on the information for confirming the obstacle.

In order to display the second obstacle avoidance prompt information, it is necessary to determine the obstacle in the moving direction outside the real-time image, so it is necessary to receive the information for confirming the obstacle obtained by the moving device 1. For example, the information for confirming the obstacle may include a depth image taken by the moving device 1 through a camera or sensor data obtained by a sensor. After receiving the information for confirming the obstacle obtained by the moving device 1, a second target obstacle can be determined according to the information for confirming the obstacle, so as to display the second obstacle avoidance prompt information in the first preset area 10 of the real-time image to prompt the second target obstacle.

In this embodiment, by receiving the information for confirming the obstacle obtained by the moving device 1, the information for confirming the obstacle can be used as the basis for confirming the obstacle, so that the second obstacle avoidance prompt information can be displayed in the first preset area 10 in the real-time image according to the information for confirming the obstacle, so that when the moving direction is outside the shooting range corresponding to the real-time image, the obstacle situation in the moving direction can be prompted by the second obstacle avoidance prompt information, thereby ensuring the applicability and accuracy of the obstacle avoidance prompt and the safety of using the moving device 1, and improving the user experience.

In some embodiments, the information for confirming the obstacle includes at least one depth image taken by the moving device 1, and the moving direction of the moving device 1 is within the shooting range corresponding to the at least one depth image; or, the information for confirming the obstacle includes sensor data acquired by the sensor of the moving device 1; or, the information for confirming the obstacle includes at least one depth image taken by the moving device 1 and sensor data acquired by the sensor of the moving device 1. The information for confirming the obstacle obtained by the moving device 1 may be one or more depth images taken by the moving device 1. When there are multiple depth images, the shooting ranges of the multiple depth images may be separated from each other or may have intersections. A depth image is an image that can characterize a distance between an object in a scene and a camera. For example, a grayscale value of a pixel in a depth image may represent the distance between the object corresponding to the pixel and the camera. The moving direction of the moving device 1 is within the shooting range corresponding to at least one depth image. Obstacle situation in the moving direction may be determined based on the depth image taken by the moving device 1, and based on the depth image, first obstacle avoidance prompt information may be displayed in the real-time image, or second obstacle avoidance prompt information may be displayed in the first preset area 10 in the real-time image.

The information for confirming the obstacle obtained by the moving device 1 may also be sensor data obtained by the sensors of the moving device 1. The obstacle in the moving direction can be determined based on the sensor data obtained by the sensor of the moving device 1, and based on the depth image, the first obstacle avoidance prompt information can be displayed in the real-time image or the second obstacle avoidance prompt information can be displayed in the first preset area 10 in the real-time image.

In this embodiment, at least one depth image captured by the moving device 1 or sensor data acquired by the sensor of the moving device 1 is used as information for confirming the obstacle, thereby realizing acquisition of information for confirming the obstacle, and providing a basis for determining the obstacle in the moving direction and displaying the first obstacle avoidance prompt information or the second obstacle avoidance prompt information. The depth image and the sensor data are used as information for confirming the obstacle, ensuring the accuracy of confirming the obstacle, thereby ensuring the applicability and accuracy of the obstacle avoidance prompt and the safety of using the moving device 1, thereby improving the user experience.

In some embodiments, the depth image is captured by a binocular camera or a panoramic camera of the moving device 1, and the sensor of the moving device 1 includes at least one of a visual sensor, a lidar sensor, or an ultrasonic sensor.

The depth image can be obtained by taking images of the binocular camera or the panoramic camera of the moving device 1. The binocular camera can use two cameras to simulate the stereoscopic vision of the human eye, and the depth information can be calculated by the difference of the images taken by the two cameras to obtain the corresponding depth image. The panoramic camera can provide a 360-degree viewing angle image with a wide field of view. The depth information of the panoramic camera can be calculated according to a depth algorithm and the corresponding depth image can be obtained, so that the depth image can be used as information for confirming the obstacle.

The sensor of the moving device 1 can be a combination of one or more visual sensors, lidar sensors or ultrasonic sensors. The visual sensors, lidar sensors and ultrasonic sensors can all be used as obstacle avoidance sensors to determine the obstacles within a certain detection range based on corresponding sensor data, so that the sensor data can be used as information for confirming the obstacle.

In this embodiment, the depth image is captured by a binocular camera or a panoramic camera of the moving device 1, so that the moving device 1 can obtain the depth image, so that the depth image can be used as information for confirming the obstacle and the accuracy of the information for confirming the obstacle is guaranteed. The sensor of the moving device 1 includes at least one of a visual sensor, a lidar sensor, or an ultrasonic sensor, and sensor data can be obtained by any one or more combinations of the visual sensor, the lidar sensor, or the ultrasonic sensor, so that the sensor data can be used as information for confirming the obstacle and the accuracy of the information for confirming the obstacle is guaranteed.

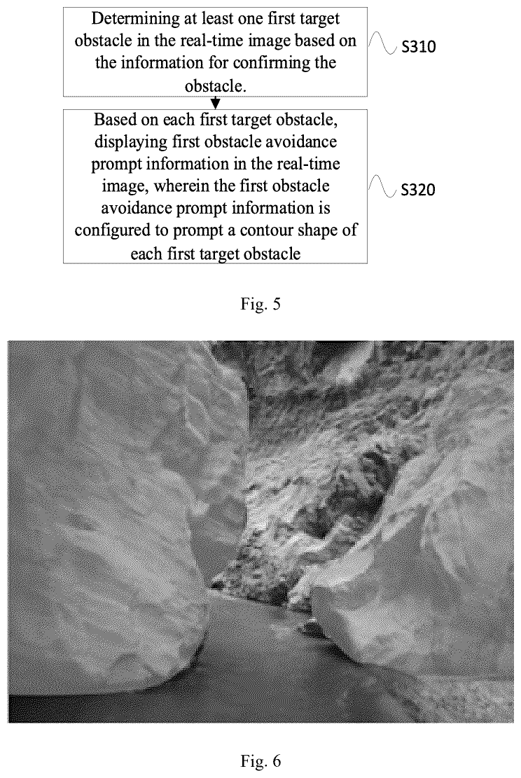

In some embodiments, referring to FIG. 5, based on the information for confirming the obstacle, the first obstacle avoidance prompt information is displayed in the real-time image, including:

S310: determining at least one first target obstacle in the real-time image based on the information for confirming the obstacle.

In step S310, at least one first target obstacle in the real-time image may be determined based on the information for confirming the obstacle, and the first target obstacle may be, for example, an obstacle that is relatively close to the moving device 1 in the real-time image. Exemplarily, the depth image captured by the moving device 1 is used as the information for confirming the obstacle, and all obstacles in the real-time image may be determined based on the depth image, and one or more obstacles that are relatively close to the moving device 1 among these obstacles may be used as the first target obstacle.

S320: based on each first target obstacle, displaying first obstacle avoidance prompt information in the real-time image, wherein the first obstacle avoidance prompt information is configured to prompt a contour shape of each first target obstacle.

In step S320, the first obstacle avoidance prompt information can be directly displayed in the real-time image according to each first target obstacle. The first obstacle avoidance prompt information can prompt a contour shape of each first target obstacle. The user can intuitively observe the contour shape of the first target obstacle according to the first obstacle avoidance prompt information, so as to determine a part of the first target obstacle that may collide with the moving device 1 according to the contour shape of the first target obstacle and determine appropriate obstacle avoidance direction.

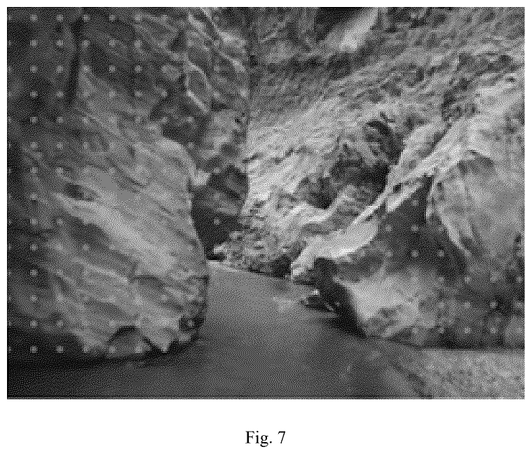

Exemplarily, the first obstacle avoidance prompt information can be displayed by color marking each first target obstacle in the real-time image as shown in FIG. 6, or by dot matrix marking each first target obstacle in the real-time image as shown in FIG. 7, so that the contour shape of the first target obstacle is prompted by the first obstacle avoidance prompt information.

In this embodiment, based on the information for confirming the obstacle, at least one first target obstacle in the real-time image is determined, and based on each first target obstacle, first obstacle avoidance prompt information is displayed in the real-time image, thereby realizing the display of the first obstacle avoidance prompt information, so that the first obstacle avoidance prompt information can prompt the contour shape of each first target obstacle. The first obstacle avoidance prompt information is clear and specific, and the user can intuitively observe the contour shape of the first target obstacle according to the first obstacle avoidance prompt information, so as to reasonably avoid the obstacle according to the first obstacle avoidance prompt information.

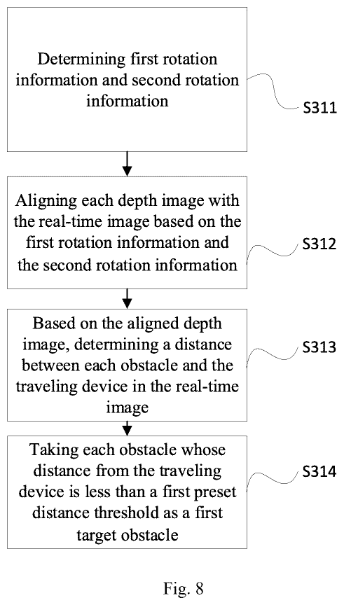

In some embodiments, the information for confirming the obstacle includes at least one depth image captured by the moving device 1. Referring to FIG. 8, based on the information for confirming the obstacle, determining at least one first target obstacle in the real-time image includes:

S311: determining first rotation information and second rotation information, where the first rotation information is configured to characterize rotation relationship between a coordinate system corresponding to each depth image and a coordinate system corresponding to the moving device, and the second rotation information is configured to characterize rotation relationship between a coordinate system corresponding to the real-time image and the coordinate system corresponding to the moving device.

In step S311, if the information for confirming the obstacle includes the depth image captured by the moving device 1, the first rotation information and the second rotation information are first determined, and the first rotation information can characterize the rotation relationship between the coordinate system corresponding to each depth image and the coordinate system corresponding to the moving device 1, that is, the relative positional relationship between the shooting range of each depth image and the moving device 1. The second rotation information can characterize the rotation relationship between the coordinate system corresponding to the real-time image and the coordinate system corresponding to the moving device 1, that is, the relative positional relationship between the shooting range of the real-time image and the moving device 1.

S312: aligning each depth image with the real-time image based on the first rotation information and the second rotation information.

In step S312, each depth image can be aligned with the real-time image according to the first rotation information and the second rotation information, so that the position of each depth image in the real-time image can be adapted to the relative position relationship between the shooting range corresponding to each depth image and the shooting range corresponding to the real-time image, thereby ensuring that the obstacle in each depth image correspond to the obstacle in the real-time image.

Exemplarily, each depth image can be converted from the coordinate system corresponding to the depth image to the coordinate system corresponding to the moving device 1 according to the first rotation information, and then each depth image can be converted from the coordinate system corresponding to the moving device 1 to the coordinate system corresponding to the real-time image according to the second rotation information, so that each depth image can be aligned with the real-time image.

S313: based on the aligned depth image, determining a distance between each obstacle and the moving device in the real-time image.

In step S313, since the depth image can represent the distance between the object and the camera, each obstacle in the real-time image can be determined according to the aligned depth image, and the distance between each obstacle and the moving device 1 can be determined.

S314: selecting each obstacle whose distance from the moving device being less than a first preset distance threshold as a first target obstacle.

In step S314, the distance between the obstacle in the real-time image and the moving device 1 may be close or far. When the distance is far, the moving device 1 can still maintain the moving direction and continue to move. If all obstacles are prompted as first target obstacles, it will cause interference to the user. Therefore, each obstacle whose distance from the moving device 1 is less than the first preset distance threshold is taken as the first target obstacle, so that only the obstacle that is close to the moving device 1 in the real-time image is taken as the first target obstacle. The first preset distance threshold may be, for example, 10 meters.

In this embodiment, by determining the first rotation information and the second rotation information, and aligning each depth image with the real-time image according to the first rotation information and the second rotation information, and then determining the distance between each obstacle in the real-time image and the moving device 1 according to each aligned depth image, each obstacle whose distance from the moving device 1 is less than the first preset distance threshold can be taken as the first target obstacle, thereby realizing the determination of the first target obstacle and providing a basis for the display of the first obstacle avoidance prompt information. Each depth image is aligned with the real-time image according to the first rotation information and the second rotation information, so that the coordinate system of the moving device 1 is used as a reference for the coordinate system conversion, thereby ensuring the alignment accuracy of each depth image with the real-time image, thereby ensuring the accuracy of determining the first target obstacle. Each obstacle whose distance from the moving device 1 is less than the first preset distance threshold is taken as the first target obstacle, ensuring that the first obstacle avoidance prompt information is displayed only when the moving device 1 is close to the obstacle, that is, when obstacle avoidance is required, thereby improving the accuracy of the obstacle avoidance prompt and reducing signal interference.

In some embodiments, the first rotation information and the second rotation information are obtained by the moving device 1 by calibrating external parameters of the camera.

Calibration of the camera's external parameters is a process of determining the conversion relationship between the camera and the external coordinate system, which may include, for example, the posture parameters of rotation and translation under multiple degrees of freedom. Calibration of the camera's external parameters can determine the relative position and posture relationship between multiple components or ranges. The rotation relationship between the coordinate system corresponding to each depth image and the coordinate system corresponding to the moving device 1 and the rotation relationship between the coordinate system corresponding to the real-time image and the coordinate system corresponding to the moving device 1 can be determined by calibrating the camera's external parameters to obtain the first rotation information and the second rotation information.

In this embodiment, by calibrating the external parameters of the camera, the first rotation information and the second rotation information are obtained, and the accuracy of the first rotation information and the second rotation information is guaranteed, which can provide a basis for aligning each depth image with the real-time image and ensure the alignment accuracy of each depth image with the real-time image, thereby making the determination of the first target obstacle more accurate and improving the accuracy of the obstacle avoidance prompt.

In some embodiments, based on each first target obstacle, first obstacle avoidance prompt information is displayed in the real-time image, including: color marking of each first target obstacle in the real-time image; or dot matrix marking of each first target obstacle in the real-time image; or grid marking of each first target obstacle in the real-time image.

As shown in FIG. 6, the first obstacle avoidance prompt information can be displayed by color-marking each first target obstacle in the real-time image, and the image area corresponding to each first target obstacle in the real-time image is filled with color to indicate the contour shape of each first target obstacle through the range of color marking. As shown in FIG. 7, the first obstacle avoidance prompt information can also be displayed by dot-matrix marking each first target obstacle in the real-time image, and the image area corresponding to each first target obstacle in the real-time image is filled with dot-matrix marking with a preset density, so as to indicate the contour shape of each first target obstacle through the range of dot-matrix marking. The first obstacle avoidance prompt information can also be displayed by grid-marking each first target obstacle in the real-time image, and the image area corresponding to each first target obstacle in the real-time image is filled with grids of a preset style to indicate the contour shape of each first target obstacle through the range of grid marking.

In this embodiment, by marking each first target obstacle with color, dot matrix or grid in the real-time image, it is achieved that the first obstacle avoidance prompt information is displayed in the real-time image and the contour shape of each first target obstacle is prompted by the first obstacle avoidance prompt information. The first obstacle avoidance prompt information is clear and specific. The user can intuitively observe the contour shape of the first target obstacle according to the color, dot matrix or grid marking, so as to reasonably avoid the obstacle according to the first obstacle avoidance prompt information. In some embodiments, the displaying the moving direction prompt information in the real-time image includes: displaying a direction prompt icon in an edge area corresponding to the moving direction of the moving device 1 in the real-time image.

If the moving direction of the moving device 1 is outside the shooting range corresponding to the real-time image, the moving direction prompt information can be displayed by displaying a moving direction prompt icon 30 in an edge area corresponding to the moving direction of the moving device 1 in the real-time image. As shown in FIG. 9, a moving direction prompt icon 30 with a pointer is displayed in the real-time image, the pointer of the moving direction prompt icon 30 points to the moving direction of the moving device 1, and the position of the moving direction prompt icon 30 in the edge area of the real-time image corresponds to the moving direction, and the user can determine the moving direction of the moving device 1 according to the position of the moving direction prompt icon 30 in the real-time image or the direction pointed to by the pointer of the moving direction prompt icon 30.

In this embodiment, the display of the moving direction prompt information is realized by displaying the moving direction prompt icon 30 in the edge area corresponding to the moving direction of the moving device 1 in the real-time image. The moving direction prompt information is clear and specific. The user can intuitively observe the moving direction of the moving device 1 according to the position of the moving direction prompt icon 30 in the real-time image or the direction pointed by the pointer of the moving direction prompt icon 30, which facilitates the adjustment and control of the moving direction and improves the user experience.

In some embodiments, the obstacle avoidance prompt method also includes: if the moving direction is outside the shooting range corresponding to the real-time image, when there is a second target obstacle in the moving direction, third obstacle avoidance prompt information is displayed in the real-time image, and the displayed third obstacle avoidance prompt information is configured to prompt that there is a second target obstacle in the moving direction.

Unlike the first target obstacle located within the shooting range corresponding to the real-time image, the second target obstacle is located outside the shooting range corresponding to the real-time image and in the moving direction of the moving device 1. If the moving direction is outside the shooting range corresponding to the real-time image, not only the second obstacle avoidance prompt information is displayed in the first preset area 10 in the real-time image, but also the third obstacle avoidance prompt information needs to be directly displayed in the real-time image when the second target obstacle exists in the moving direction, so as to prompt the user through the third obstacle avoidance prompt information that the second target obstacle exists in the moving direction and the moving direction of the moving device 1 needs to be adjusted in time to avoid the obstacle.

In this embodiment, when the moving direction is outside the shooting range corresponding to the real-time image and there is a second target obstacle in the moving direction, the third obstacle avoidance prompt information can be displayed in the real-time image to prompt the presence of the second target obstacle in the moving direction. This allows the user to avoid the obstacle according to the third obstacle avoidance prompt information when the user is unable to observe the obstacle situation in the moving direction through the real-time image, thereby ensuring the applicability and accuracy of the obstacle avoidance prompt and the safety of use of the moving device 1, thereby improving the user experience.

In some embodiments, the third obstacle avoidance prompt information is displayed in the real-time image, including: color marking or pattern marking a second preset area 20 of the real-time image and making the second preset area 20 flash in a breathing manner, or changing the color of the direction prompt icon and making the direction prompt icon flash in a breathing manner. It can also be that the second preset area 20 of the real-time image is color marked or pattern marked and the second preset area 20 flashes in a breathing manner, while the color of the direction prompt icon is changed and the direction prompt icon flashes in a breathing manner.

In one embodiment, when the moving direction is outside the shooting range corresponding to the real-time image and there is a second target obstacle in the moving direction, the third obstacle avoidance prompt information can be displayed by color marking or pattern marking the second preset area 20 of the real-time image and making the second preset area 20 flash in a breathing manner. When the second preset area 20 flashes in the breathing manner, the user can determine that there is a second target obstacle in the moving direction. In one embodiment, when the moving direction is outside the shooting range corresponding to the real-time image and there is a second target obstacle in the moving direction, the third obstacle avoidance prompt information can also be displayed by changing the color of the direction prompt icon and making the direction prompt icon flash in a breathing manner. The initial color of the direction prompt icon can be white, for example, and the color of the direction prompt icon can be changed to red, and the direction prompt icon can be made to flash in a breathing manner. When the color of the direction prompt icon changes and flashes in the breathing manner, the user can determine that there is a second target obstacle in the moving direction.

In this embodiment, when the moving direction is outside the shooting range corresponding to the real-time image and there is a second target obstacle in the moving direction, the third obstacle avoidance prompt information is displayed by color marking or pattern marking the second preset area 20 of the real-time image and making the second preset area 20 flash in a breathing manner, or by changing the color of the direction prompt icon and making the direction prompt icon flash in a breathing manner. The third obstacle avoidance prompt information is clear and specific, and the user can determine whether there is a second target obstacle in the moving direction according to the second preset area 20 or the direction prompt icon in the real-time image. When the obstacle situation in the moving direction cannot be observed through the real-time image, the obstacle can be avoided according to the third obstacle avoidance prompt information, which ensures the applicability and accuracy of the obstacle avoidance prompt and the safety of the use of the moving device 1, thereby improving the user experience.

In some embodiments, the second preset area 20 is located at an edge of the real-time image. As shown in FIG. 9, the second preset area 20 is located at the edge of the real-time image. When the real-time image is circular, the second preset area 20 can be a ring area with a circular edge. The marking color of the second preset area 20 can be red, for example. When the moving direction is outside the shooting range corresponding to the real-time image and there is a second target obstacle in the moving direction, the second preset area 20 flashes in a breathing manner, and the user can determine that there is a second target obstacle in the moving direction.

In this embodiment, the second preset area 20 is set at the edge of the real-time image, and the third obstacle avoidance prompt information can be displayed through the breathing flashing of the second preset area 20 at the edge of the real-time image, so that when the user cannot observe the obstacle in the moving direction through the real-time image, the user can avoid the obstacle according to the third obstacle avoidance prompt information, and the display of the third obstacle avoidance prompt information will not interfere with the display of the real-time image, thereby improving the display effect and user experience.

In some embodiments, referring to FIG. 10, based on the information for confirming the obstacle, the second obstacle avoidance prompt information is displayed in the first preset area 10, including:

S410: displaying a moving image of an area corresponding to the moving direction in the shooting image in a first preset area.

In step S410, since the moving direction is outside the shooting range corresponding to the real-time image, the area corresponding to the real-time image in the shooting image, i.e., the panoramic image, is different from the area corresponding to the image in the moving direction in the panoramic image. In order to be able to observe the image in the moving direction, the moving image of the area corresponding to the moving direction in the shooting image can be displayed in the first preset area 10. As shown in FIG. 9, the shape of the first preset area 10 can be, for example, a rectangle. The first preset area 10 is close to the edge of the real-time image, and the moving image can be displayed in the first preset area 10.

S420: determining at least one second target obstacle in the moving image based on the information for confirming the obstacle.

In step S420, at least one second target obstacle in the moving image may be determined based on the information for confirming the obstacle, and the second target obstacle may be, for example, an obstacle that is relatively close to the moving device 1 in the moving image. Exemplarily, the depth image captured by the moving device 1 is used as the information for confirming the obstacle, the depth image may be aligned with the moving image, and all obstacles in the moving image may be determined based on the depth image, and then one or more obstacles that are relatively close to the moving device 1 among these obstacles may be used as the second target obstacle.

S430: based on each second target obstacle, displaying second obstacle avoidance prompt information in the moving image.

In step S430, second obstacle avoidance prompt information can be displayed in the moving image displayed in the first preset area 10 according to each second target obstacle. The second obstacle avoidance prompt information can prompt the second target obstacle in the moving image. The user can understand the obstacle situation in the moving direction according to the second obstacle avoidance prompt information to perform reasonable obstacle avoidance.

In this embodiment, by displaying the moving image of the area corresponding to the moving direction in the shooting image in the first preset area 10, the user can observe the image in the moving direction through the first preset area 10. According to the information for confirming the obstacle, at least one second target obstacle in the moving image is determined, and according to each second target obstacle, the second obstacle avoidance prompt information is displayed in the moving image, so that the second obstacle avoidance prompt information can prompt each second target obstacle, and the user can reasonably avoid the obstacle according to the second obstacle avoidance prompt information. In some embodiments, the second obstacle avoidance prompt information is configured to prompt the relative direction and relative distance between each second target obstacle and the moving device 1.

In this embodiment, the second obstacle avoidance prompt information displayed in the moving image can prompt the relative direction and relative distance between each second target obstacle and the moving device 1. The user can determine the relative position relationship between one or more second target obstacles and the moving device 1 in the moving direction according to the second obstacle avoidance prompt information, which facilitates the user to reasonably avoid the obstacle according to the second obstacle avoidance prompt, thereby improving the user experience.

In some embodiments, referring to FIG. 11, determining at least one second target obstacle in the moving image based on the information for confirming the obstacle includes:

S421. determining a distance between each obstacle and the moving device in the moving image based on the information for confirming the obstacle.

In step S421, the depth image may be used as the information for confirming the obstacle. According to the depth image aligned with the moving image, each obstacle in the moving image and the distance between each obstacle and the moving device 1 may be determined. S422: selecting each obstacle whose distance from the moving device being less than a second preset distance threshold as a second target obstacle.

In step S422, the distance between the obstacle in the moving image and the moving device 1 may be close or far. When the distance is far, the moving device 1 can still maintain the moving direction and continue to travel. If all obstacles are used as second target obstacles for prompting, it would cause interference to the user. Therefore, each obstacle whose distance to the moving device 1 is less than the second preset distance threshold is used as the second target obstacle, so that only the obstacles that are close to the moving device 1 in the moving image are used as the second target obstacle. The second preset distance threshold may be, for example, 10 meters.

In this embodiment, the distance between each obstacle in the moving image and the moving device 1 is determined based on the information for confirming the obstacle, and each obstacle whose distance to the moving device 1 is less than the second preset distance threshold is used as the second target obstacle, thereby realizing the determination of the second target obstacle and providing a basis for the display of the second obstacle avoidance prompt information. Each obstacle whose distance to the moving device 1 is less than the second preset distance threshold is used as the second target obstacle, ensuring that the second obstacle avoidance prompt information is displayed only when the moving device 1 is close to the obstacle, that is, when obstacle avoidance is required, thereby improving the accuracy of the obstacle avoidance prompt and reducing signal interference.

In some embodiments, based on each second target obstacle, displaying the second obstacle avoidance prompt information in the moving image includes: color marking or pattern marking of multiple third preset areas 40 in the moving image. Among them, each third preset area 40 is located at a bottom of the moving image and arranged along a horizontal direction of the moving image, and different third preset areas 40 correspond to different preset direction ranges.

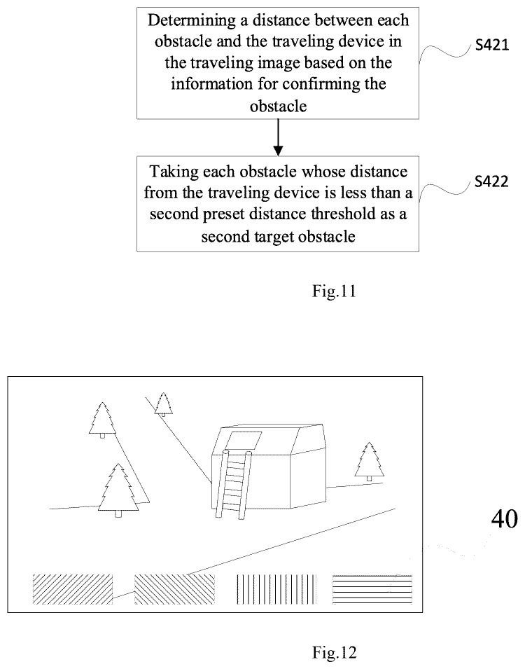

The second obstacle avoidance prompt information can be displayed by color marking or pattern marking of multiple third preset areas 40 of the moving image, so as to prompt the relative direction and relative distance between each second target obstacle and the moving device 1 through the color or pattern displayed in each third preset area 40. As shown in FIG. 12, each third preset area 40 is located at the bottom of the moving image, and the third preset areas 40 are arranged along the horizontal direction of the moving image. Different third preset areas 40 can correspond to different preset direction ranges in the moving image. Whether there is a second target obstacle in the corresponding direction and the distance between the second target obstacle and the moving device 1 can be determined based on the color or pattern marked in the third preset area 40, so as to prompt the relative direction and relative distance between each second target obstacle and the moving device 1.

In this embodiment, by color marking or pattern marking of multiple third preset areas 40 of the moving image, the second obstacle avoidance prompt information is displayed in the moving image, so that the user can determine whether there is a second target obstacle in the corresponding direction and determine the distance between the second target obstacle and the moving device 1 according to the color or pattern marked in the third preset area 40. The second obstacle avoidance prompt information is clear and specific, which facilitates reasonable obstacle avoidance according to the second obstacle avoidance prompt, thereby improving the user experience.

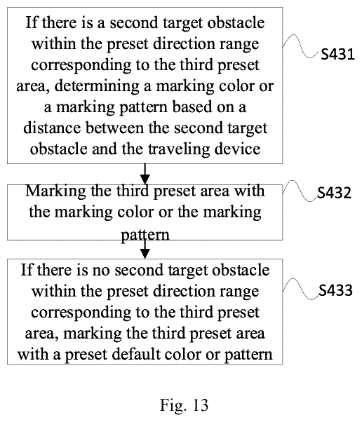

In some embodiments, performing color marking or pattern marking on multiple third preset areas 40 of the moving image includes: performing the following color marking or pattern marking process as shown in FIG. 13 on each third preset area 40:

S431: if there is a second target obstacle within the preset direction range corresponding to the third preset area, determining a marking color or a marking pattern based on a distance between the second target obstacle and the moving device.

S432: marking the third preset area with the marking color or the marking pattern. In step S431 and step S432, if there is a second target obstacle within the preset direction range corresponding to any third preset area 40 among the multiple third preset areas 40, the marking color or marking pattern can be determined according to the distance between the second target obstacle and the moving device 1, and the third preset area 40 can be marked with the determined marking color or marking pattern.

For example, as shown in FIG. 12, if the distance between the second target obstacle in the preset direction range corresponding to a third preset area 40 and the moving device 1 is 2-10 meters, the third preset area 40 is marked in yellow, and if the distance between the second target obstacle in the preset direction range corresponding to a third preset area 40 and the moving device 1 is 0-2 meters, the third preset area 40 is marked in red. The user can determine the distance between the second target obstacle in the preset direction range corresponding to the third preset area 40 and the moving device 1 according to the marking color or marking pattern of the third preset area 40, so as to determine the relative direction and relative distance between the second target obstacle and the moving device 1 through the second obstacle avoidance prompt information.

S433: if there is no second target obstacle within the preset direction range corresponding to the third preset area, marking the third preset area with a preset default color or a preset default pattern.

In step S433, if there is no second target obstacle within the preset direction range corresponding to any third preset area 40 among the plurality of third preset areas 40, the third preset area 40 is marked with a preset default color or a preset default pattern. Exemplarily, as shown in FIG. 12, if there is no second target obstacle within the preset direction range corresponding to a third preset area 40, the third preset area 40 is marked with green. The user can determine that there is no second target obstacle within the preset direction range corresponding to the third preset area 40 according to the preset default color or preset default pattern marked by the third preset area 40, so as to determine the preset direction range in which there is no second target obstacle through the second obstacle avoidance prompt information.

In this embodiment, when there is a second target obstacle within the preset direction range corresponding to the third preset area 40, the marking color or marking pattern is determined according to the distance between the second target obstacle and the moving device 1, and the third preset area 40 is marked with the marking color or marking pattern, and the user can determine the distance between the second target obstacle existing within the preset direction range corresponding to the third preset area 40 and the moving device 1 according to the marking color or marking pattern of the third preset area 40. When there is no second target obstacle within the preset direction range corresponding to the third preset area 40, the third preset area 40 is marked with a preset default color or a preset default pattern, and the user can determine that there is no second target obstacle within the preset direction range corresponding to the third preset area 40 according to the preset default color or preset default pattern marked by the third preset area 40. The display of the second obstacle avoidance prompt information is realized, so that the second obstacle avoidance prompt information is clear and specific, which is convenient for a user to reasonably avoid the obstacle according to the second obstacle avoidance prompt, thereby improving the user experience.

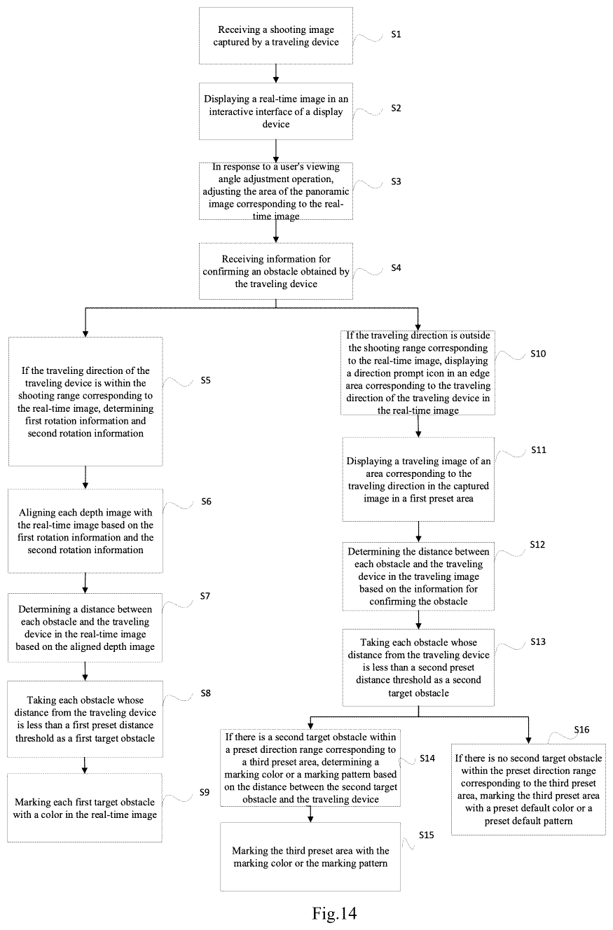

In an exemplary embodiment, an obstacle avoidance prompt method is provided, which is applied to a display device 2, where the display device 2 may be, for example, a wearable device such as a pair of glasses or a terminal device such as a mobile phone capable of displaying images. Referring to FIG. 14, the obstacle avoidance prompt method includes: S1: receiving a shooting image captured by a moving device;

S2: displaying a real-time image in an interactive interface of a display device, where the real-time image corresponds to an image of at least a partial area in the shooting image; S3: in response to a user's viewing angle adjustment operation, adjusting the area of the panoramic image corresponding to the real-time image;

S4: receiving information for confirming an obstacle obtained by the moving device;

S5. if the moving direction of the moving device is within the shooting range corresponding to the real-time image, determining first rotation information and second rotation information, the first rotation information being configured to characterize the rotation relationship between the coordinate system corresponding to each depth image and the coordinate system corresponding to the moving device, and the second rotation information being configured to characterize the rotation relationship between the coordinate system corresponding to the real-time image and the coordinate system corresponding to the moving device; S6: aligning each depth image with the real-time image based on the first rotation information and the second rotation information;

S7: determining a distance between each obstacle and the moving device in the real-time image based on the aligned depth image;

S8: selecting each obstacle whose distance from the moving device being less than a first preset distance threshold as a first target obstacle;

S9: marking each first target obstacle with a color in the real-time image;

S10: if the moving direction is outside the shooting range corresponding to the real-time image, displaying a direction prompt icon in an edge area corresponding to the moving direction of the moving device in the real-time image;

S11: displaying a moving image of an area corresponding to the moving direction in the captured image in a first preset area;

S12: determining the distance between each obstacle and the moving device in the moving image based on the information for confirming the obstacle;

S13: selecting each obstacle whose distance from the moving device being less than a second preset distance threshold as a second target obstacle;

S14: if there is a second target obstacle within a preset direction range corresponding to a third preset area, determining a marking color or a marking pattern based on the distance between the second target obstacle and the moving device;

S15: marking the third preset area with the marking color or the marking pattern; and S16: if there is no second target obstacle within the preset direction range corresponding to the third preset area, marking the third preset area with a preset default color or a preset default pattern.

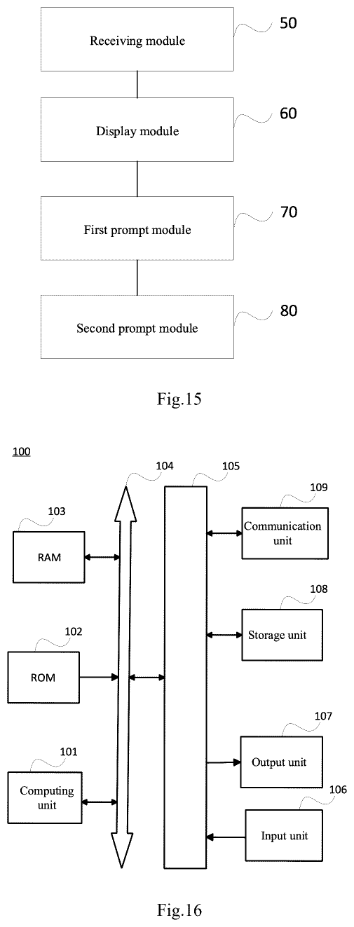

In this embodiment, by receiving the shooting image taken by the moving device 1 and displaying the real-time image in the interactive interface of the display device 2, the first obstacle avoidance prompt information can be displayed when the moving direction is within the shooting range corresponding to the real-time image, and the moving direction prompt information and the second obstacle avoidance prompt information can be displayed when the moving direction is outside the shooting range corresponding to the real-time image, so that obstacle avoidance prompts and moving direction prompt in different scenarios can be realized through the real-time image. The first obstacle avoidance prompt information and the second obstacle avoidance prompt information can respectively prompt obstacles within and outside the shooting range corresponding to the real-time image, and the moving direction prompt information can prompt the moving direction outside the real-time image. Regardless of any changes in the shooting range corresponding to the real-time image and the moving direction of the moving device 1, the moving direction of the moving device 1 and the obstacle situation in the moving direction can be prompted through the real-time image, thereby ensuring the applicability and accuracy of the obstacle avoidance prompt and the safety of using the moving device 1, and improving the user experience. In an exemplary embodiment, an obstacle avoidance prompt device is provided, which is applied to a display device 2. The display device 2 can be, for example, a wearable device such as a pair of glasses that can display images or a terminal device such as a mobile phone. As shown in FIG. 15, the obstacle avoidance prompt device includes a receiving module 50, a display module 60, a first prompt module 70, and a second prompt module 80. The receiving module 50 is configured to receive a shooting image taken by the moving device 1. The display module 60 is configured to display a real-time image in the interactive interface of the display device 2, and the real-time image corresponds to the image of at least a part of the shooting image. The first prompt module 70 is configured to display the first obstacle avoidance prompt information in the real-time image if the moving direction of the moving device 1 is within the shooting range corresponding to the real-time image. The second prompt module 80 is configured to display the moving direction prompt information in the real-time image if the moving direction of the moving device 1 is outside the shooting range corresponding to the real-time image, and display the second obstacle avoidance prompt information in a first preset area 10 in the real-time image.

In this embodiment, the shooting image taken by the moving device 1 is received by the receiving module 50, and the real-time image is displayed in the interactive interface of the display device 2 by the display module 60. The first obstacle avoidance prompt information can be displayed by the first prompt module 70 when the moving direction is within the shooting range corresponding to the real-time image, and the moving direction prompt information and the second obstacle avoidance prompt information can be displayed by the second prompt module 80 when the moving direction is outside the shooting range corresponding to the real-time image, so that obstacle avoidance prompts and moving direction prompt in different scenes can be realized through the real-time image. The first obstacle avoidance prompt information and the second obstacle avoidance prompt information can respectively prompt the obstacle within and outside the shooting range corresponding to the real-time image, and the moving direction prompt information can prompt the moving direction outside the real-time image. Regardless of any changes in the shooting range corresponding to the real-time image and the moving direction of the moving device 1, the moving direction of the moving device 1 and the obstacle situation in the moving direction can be prompted through the real-time image, thereby ensuring the applicability and accuracy of the obstacle avoidance prompt and the safety of the use of the moving device 1, thereby improving the user experience.

In one embodiment, the shooting image includes a panoramic image captured by a panoramic camera of the moving device 1, and the real-time image corresponds to an image of a partial area in the panoramic image.

In one embodiment, the obstacle avoidance prompting device further includes an adjustment module, and the adjustment module is configured to: in response to the user's viewing angle adjustment operation, adjust the area of the panoramic image corresponding to the real-time image.

In one embodiment, the receiving module 50 is further configured to receive information for confirming an obstacle obtained by the moving device 1. The first prompting module 70 is further configured to display first obstacle avoidance prompting information in the real-time image based on the information for confirming the obstacle. The second prompting module 80 is further configured to display second obstacle avoidance prompting information in the first preset area 10 based on the information for confirming the obstacle.

In one embodiment, the information for confirming the obstacle includes at least one depth image taken by the moving device 1, and the moving direction of the moving device 1 is located within the shooting range corresponding to the at least one depth image; and/or, the information for confirming the obstacle includes sensor data acquired by the sensor of the moving device 1.

In one embodiment, the depth image is captured by a binocular camera or a panoramic camera of the moving device 1; the sensor of the moving device 1 includes at least one of a visual sensor, a lidar sensor, or an ultrasonic sensor.

In one embodiment, the first prompt module 70 is also configured to: determine at least one first target obstacle in the real-time image based on the information for confirming the obstacle; based on each first target obstacle, display first obstacle avoidance prompt information in the real-time image, and the first obstacle avoidance prompt information is configured to prompt a contour shape of each first target obstacle.

In one embodiment, the information for confirming the obstacle includes at least one depth image taken by the moving device 1, and the first prompt module 70 is also configured to: determine first rotation information and second rotation information, the first rotation information is configured to characterize the rotation relationship between the coordinate system corresponding to each depth image and the coordinate system corresponding to the moving device 1, and the second rotation information is configured to characterize the rotation relationship between the coordinate system corresponding to the real-time image and the coordinate system corresponding to the moving device 1; based on the first rotation information and the second rotation information, align each depth image with the real-time image; based on each aligned depth image, determine the distance between each obstacle in the real-time image and the moving device 1; and take each obstacle whose distance to the moving device 1 is less than a first preset distance threshold as a first target obstacle.

In one embodiment, the first rotation information and the second rotation information are obtained by the moving device 1 by calibrating external parameters of the camera. In one embodiment, the first prompt module 70 is further configured to: mark each first target obstacle with a color in the real-time image; or mark each first target obstacle with a dot matrix in the real-time image; or mark each first target obstacle with a grid in the real-time image.

In one embodiment, the second prompt module 80 is further configured to: display a direction prompt icon in an edge area corresponding to the moving direction of the moving device 1 in the real-time image.

In one embodiment, the obstacle avoidance prompt device also includes a third prompt module, which is configured to: if the moving direction is outside the shooting range corresponding to the real-time image and there is a second target obstacle in the moving direction, display a third obstacle avoidance prompt information in the real-time image, and the displayed third obstacle avoidance prompt information is configured to prompt presence of a second target obstacle in the moving direction.

In one embodiment, the third prompt module is also configured to: color or pattern mark a second preset area 20 of the real-time image and make the second preset area 20 flash in a breathing manner; and/or change the color of the direction prompt icon and make the direction prompt icon flash in a breathing manner.

In one embodiment, the second preset area 20 is located at the edge of the real-time image. In one embodiment, the second prompt module 80 is also configured to: display a moving image of an area in the shooting image corresponding to the moving direction in the first preset area 10; determine at least one second target obstacle in the moving image based on information for confirming the obstacle; and display second obstacle avoidance prompt information in the moving image based on each second target obstacle.

In one embodiment, the second obstacle avoidance prompt information is configured to prompt relative direction and relative distance between each second target obstacle and the moving device 1.

In one embodiment, the second prompt module 80 is also configured to: determine the distance between each obstacle in the moving image and the moving device 1 based on the information for confirming the obstacle; and set each obstacle whose distance to the moving device 1 is less than a second preset distance threshold as a second target obstacle. In one embodiment, the second prompt module 80 is also configured to: color or pattern mark multiple third preset areas 40 of the moving image; wherein each third preset area 40 is located at the bottom of the moving image and is arranged along the horizontal direction of the moving image, and different third preset areas 40 correspond to different preset direction ranges.

In one embodiment, the second prompt module 80 is also configured to: perform the following color marking or pattern marking process on each third preset area 40: if there is a second target obstacle within the preset direction range corresponding to the third preset area 40, determine the marking color or marking pattern based on the distance between the second target obstacle and the moving device 1; mark the third preset area 40 with the marking color or marking pattern; if there is no second target obstacle within the preset direction range corresponding to the third preset area 40, mark the third preset area 40 with a preset default color or a preset default pattern.

Each module in the above obstacle avoidance prompt device can be implemented in whole or in part by software, hardware, or a combination thereof. Each module can be embedded in or independent of a processor or circuitry in a computer device in the form of hardware, or can be stored in a memory in a computer device in the form of software, so that the processor can call and execute the operations corresponding to each module.

In an exemplary embodiment, a computer device is provided, including a processor or circuitry and a memory, wherein the memory stores a computer program, and when the processor or circuitry executes the computer program, the steps of any of the above obstacle avoidance prompt methods are implemented.

In an exemplary embodiment, a non-transitory computer-readable storage medium is provided, on which a computer program is stored, and when the computer program is executed by a processor, the steps of any of the above obstacle avoidance prompt methods are implemented. The computer-readable storage medium may be a ROM, a random access memory (RAM), a CD-ROM, a magnetic tape, a floppy disk, an optical data storage device, etc.

Referring to FIG. 16, a block diagram of a computer device that can be used as the display device 2 of the present disclosure will now be described, and the computer device includes a computing unit 101, which can perform various appropriate actions and processes according to a computer program stored in a read-only memory (ROM) 102 or a computer program loaded from a storage unit 108 into a random access memory (RAM) 103. In the RAM 103, various programs and data required for the operation of the computer device 100 can also be stored. The computing unit 101, the ROM 102, and the RAM 103 are connected to each other via a bus 104. An input/output (I/O) interface 105 is also connected to the bus 104.

A plurality of components in the computer device 100 are connected to the I/O interface 105, including: an input unit 106, an output unit 107, a storage unit 108, and a communication unit 109. The input unit 106 may be any type of device capable of inputting information to the computer device 100, the input unit 106 may receive input digital or character information, and generate key signal inputs related to user settings and/or function control of the computer device 100, and may include but is not limited to a mouse, a keyboard, a touch screen, a track pad, a track ball, a joystick, a microphone, and/or a remote controller. The output unit 107 may be any type of device capable of presenting information, and may include but is not limited to a display, a speaker, a video/audio output terminal, a vibrator, and/or a printer. The storage unit 108 may include but is not limited to a disk, an optical disk. The communication unit 109 allows the computer device 100 to exchange information/data with other devices through a computer network such as the Internet and/or various telecommunication networks, and may include but is not limited to a modem, a network card, an infrared communication device, a wireless communication transceiver, and/or a chipset, such as a Bluetooth™ device, a WiFi device, a WiMax device, a cellular communication device, and/or the like.

The computing unit 101 may be a variety of general and/or special processing components with processing and computing capabilities. Some examples of the computing unit 101 include, but are not limited to, a central processing unit (CPU), a graphics processing unit (GPU), various dedicated artificial intelligence (AI) computing chips, various computing units running machine learning model algorithms, digital signal processors (DSPs), and any appropriate processors, controllers, microcontrollers, etc. The computing unit 101 performs the various methods and processes described above, such as the obstacle avoidance prompt method. For example, in some embodiments, the obstacle avoidance prompt method may be implemented as a computer software program, which is tangibly contained in a machine-readable medium, such as a storage unit 108. In some embodiments, a part or all of the computer program may be loaded and/or installed on the computer device 100 via ROM 102 and/or the communication unit 109. When the computer program is loaded into RAM 103 and executed by the computing unit 101, one or more steps of the obstacle avoidance prompt method described above may be performed. Alternatively, in other embodiments, the computing unit 101 may be configured to perform the obstacle avoidance prompt method in any other appropriate manner (e.g., by means of firmware).

The computer device 100 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components to execute the above-mentioned obstacle avoidance prompt method.

Those skilled in the art will readily appreciate other embodiments of the present disclosure after considering the specification and practicing the disclosure disclosed herein. This application is intended to cover any variations, uses or adaptations of the present disclosure that follow the general principles of the present disclosure and include common knowledge or customary techniques in the art that are not disclosed in this disclosure. The specification and examples are to be considered as exemplary only, and the true scope and spirit of the present disclosure are indicated by the following claims. The above-described embodiments only express several implementation methods of the present application, and the descriptions thereof are relatively specific and detailed, but they cannot be understood as limiting the scope of the present application. It should be pointed out that, for a person of ordinary skill in the art, several variations and improvements can be made without departing from the concept of the present application, and these all belong to the protection scope of the present application. Therefore, the protection scope of the present application shall be subject to the attached claims.

What is claimed is:

1. An obstacle avoidance prompting device, comprising circuitry configured to:
receive a shooting image captured by a moving object;
display a real-time image in an interactive interface of a display, wherein the real-time image corresponds to an image of at least a partial area of the shooting image;
if a moving direction of the moving object is within a shooting range, display a first obstacle avoidance prompt information in the real-time image; and
if the moving direction of the moving object is outside the shooting range, display moving direction prompt information and display a second obstacle avoidance prompt information in a first preset area in the real-time image.

2. The obstacle avoidance prompting device according to claim 1, wherein the shooting image includes a panoramic image taken by a panoramic camera of the moving object, and the real-time image corresponds to an image of a partial area in the panoramic image.

3. The obstacle avoidance prompting device according to claim 2, wherein the circuitry is further configured to:
in response to a user's operation, adjust the partial area of the panoramic image

4. The obstacle avoidance prompting device according to claim 1, wherein the circuitry is further configured to receive information for confirming an obstacle obtained by the moving object.

5. The obstacle avoidance prompting device according to claim 4,
wherein the displaying the first obstacle avoidance prompt information in the real-time image comprises:
displaying the first obstacle avoidance prompt information in the real-time image based on the information for confirming the obstacle; and/or
the displaying the second obstacle avoidance prompt information in the first preset area in the real-time image comprises:
displaying the second obstacle avoidance prompt information in the first preset area based on the information for confirming the obstacle.

6. The obstacle avoidance prompting device according to claim 4, wherein the information for confirming the obstacle includes at least one depth image taken by the moving object, wherein the moving direction of the moving object is located within a shooting range corresponding to the at least one depth image; and/or,
the information for confirming the obstacle includes sensor data acquired by a sensor of the moving object.

7. The obstacle avoidance prompting device according to claim 6, wherein the at least one depth image is taken by a binocular camera or a panoramic camera within the moving object.

8. The obstacle avoidance prompting device according to claim 4, wherein the displaying the first obstacle avoidance prompt information in the real-time image based on the information for confirming the obstacle comprises:
determining at least one first target obstacle in the real-time image based on the information for confirming the obstacle; and
displaying the first obstacle avoidance prompt information based on each of the at least one first target obstacle in the real-time image,
wherein the first obstacle avoidance prompt information is configured to prompt a contour shape of each of the at least one first target obstacle.

9. The obstacle avoidance prompting device according to claim 8, wherein the information for confirming the obstacle includes at least one depth image taken by a camera of the moving object, and the determining the at least one first target obstacle in the real-time image based on the information for confirming the obstacle includes:
determining first rotation information and second rotation information, wherein the first rotation information is configured to characterize rotation relationship between a coordinate system corresponding to each of the at least one depth image and a coordinate system corresponding to the moving object, and the second rotation information is configured to characterize rotation relationship between a coordinate system corresponding to the real-time image and the coordinate system corresponding to the moving object;
aligning each of the at least one depth image with the real-time image based on the first rotation information and the second rotation information to obtain an aligned depth image;
determining a distance between each obstacle in the real-time image and the moving object based on the aligned depth image; and
selecting each obstacle whose distance from the moving object being less than a first preset distance threshold as the first target obstacle.

10. The obstacle avoidance prompting device according to claim 8, wherein the displaying the first obstacle avoidance prompt information in the real-time image based on each of the at least one first target obstacle comprises:
marking each of the at least one first target obstacle with a color in the real-time image;
marking each of the at least one first target obstacle with a dot matrix in the real-time image; or,
marking each of the at least one first target obstacle with a grid in the real-time image.

11. The obstacle avoidance prompting device according to claim 1, wherein the displaying the moving direction prompt information in the real-time image comprises:
displaying a direction prompt icon corresponding to the moving direction of the moving object in the real-time image.

12. The obstacle avoidance prompting device according to claim 11, wherein the circuitry is further configured to:
determine that the moving direction is outside the shooting range corresponding to the real-time image and there is a second target obstacle in the moving direction; and
display third obstacle avoidance prompt information in the real-time image, wherein the third obstacle avoidance prompt information is configured to prompt the second target obstacle in the moving direction.

13. The obstacle avoidance prompting device according to claim 12, wherein the displaying the third obstacle avoidance prompt information in the real-time image comprises:
marking a second preset area of the real-time image with a color or a pattern and making the second preset area flash in a breathing manner; and/or
changing a color of the direction prompt icon and making the direction prompt icon flash in a breathing manner,
wherein the second preset area is located at an edge of the real-time image.

14. The obstacle avoidance prompting device according to claim 4, wherein the displaying the second obstacle avoidance prompt information in the first preset area based on the information for confirming the obstacle comprises:
displaying a moving image of an area corresponding to the moving direction in the shooting image in the first preset area;
determining at least one second target obstacle in the moving image based on the information for confirming the obstacle; and
displaying the second obstacle avoidance prompt information in the moving image based on each of the at least one second target obstacle,
wherein the second obstacle avoidance prompt information is configured to prompt relative direction and relative distance between each of the at least one second target obstacle and the moving object.

15. The obstacle avoidance prompting device according to claim 14, wherein the determining at least one second target obstacle in the moving image based on the information for confirming the obstacle comprises:
determining a distance between each obstacle in the moving image and the moving object based on the information for confirming the obstacle; and
selecting each obstacle whose distance from the moving object being less than a second preset distance threshold as the second target obstacle.

16. The obstacle avoidance prompting device according to claim 14, wherein the displaying the second obstacle avoidance prompt information in the moving image based on each of the at least one second target obstacles comprises:
marking multiple third preset areas of the moving image with colors or patterns,
wherein each of the third preset areas is located at a bottom of the moving image and is arranged along a horizontal direction of the moving image, and different third preset areas correspond to different preset direction ranges.

17. The obstacle avoidance prompting device according to claim 16, wherein the marking multiple third preset areas of the moving image with colors or patterns comprises:
in a case that the second target obstacle exists within a preset direction range corresponding to one of the third preset areas, determining a marking color or a marking pattern based on a distance between the second target obstacle and the moving object;
marking the one of the third preset areas with the marking color or the marking pattern; and
if no second target obstacle exists within a preset direction range corresponding to another one of the third preset areas, marking the another one of the third preset areas with a preset default color or a preset default pattern.

18. A computer device, comprising at least one memory and at least one processor, wherein the at least one memory stores a computer program, wherein the at least one processor, when executing the computer program, is configured to:
receive a shooting image captured by a moving object;
display a real-time image in an interactive interface of a display, wherein the real-time image corresponds to an image of at least a partial area of the shooting image;
if a moving direction of the moving object is within a shooting range, display first obstacle avoidance prompt information in the real-time image; and
if the moving direction of the moving object is outside the shooting range, display moving direction prompt information in the real-time image and display second obstacle avoidance prompt information in a first preset area in the real-time image.

19. The computer device according to claim 18, wherein the moving object is an unmanned aerial vehicle or a remote-controlled vehicle, and the display is a pair of glasses or a mobile phone.

20. A system, comprising:
the computer device according to claim 18;
the moving object; and
the display.
